(19) United States
(12) Patent Application Publication
(10) Pub. No.: US 2008/0289154 A1
(43) Pub. Date: Nov. 27, 2008

(54) Device and Method for Fixing a Trim Component on a Motor Vehicle Recess Post

(75) Inventors: Philippe Guerlin, Mennecy (FR); Stephane Mossu, Magny-les-Hameaux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault S.A.S., Boulogne Billancourt (FR)

(21) Appl. No.: 12/088,789

(22) PCT Filed: Sep. 22, 2006
(86) PCT No.: PCT/FR2006/050933

§ 371 Date: Jul. 21, 2008

(30) Foreign Application Priority Data
Sep. 30, 2005 (FR) 0510012

(51) Int. Cl. F16B 2/20; B60R 13/02

(52) U.S. Cl. 24/289

(57) ABSTRACT

A device for fixing a trim component on the inner surface of a motor vehicle recess post, including a series of staples including each on one side a fixing mechanism configured to be snapped-on in an opening provided on the inner surface of the post. A clearance to receive a trim component of the body roof is provided between the staple and an inner surface of the trim.

The present invention relates to a device and a method for attaching a trim to the interior face of a post flanking a window recess, particularly an A-post, in a motor vehicle.

An attachment device of this kind has been described in EP 1093978A1. This attachment device comprises a series of clips each comprising, at one end, attachment means intended to be clipped into an opening made in the interior face of said post and, at the opposite end, locking means intended to collaborate with complementary means that project from the internal face of the trim in order to lock this trim to the clip.

The trim attached in this way is shaped to house a collection of airbags and to prevent it from being ejected into the passenger compartment when the airbags deploy. The post trim therefore partially covers an edge of the headlining. Thus, when pressure is exerted on the post trim, the headlining has a tendency to move, which may give a poor impression in terms of perceived quality.

It is an object of the present invention to make improvements to the above known attachment device.

According to the invention, this attachment device is characterized in that, between the clip and an internal face of the trim there is a gap intended to accommodate a headlining.

According to another specific feature of the invention, each clip comprises, a certain distance away from its surface that is intended to bear against the interior face of the post a fin running substantially parallel to the internal surface of the post, this fin being intended to be covered by said trim in such a way that a gap exists between said fin and the trim.

This fin thus constitutes a surface that leaves a gap with respect to the post trim so that the headlining can fit into this gap thus limiting the movement of the headlining.

According to a preferred embodiment of the invention, the surface of the clip that is intended to rest against the post is formed on a base which is separated from said fin by flexible connecting tabs.

These flexible connecting tabs are thus capable of absorbing the forces applied to the post trim.

According to other specific features of the invention:
said surface of the clip includes a clip-fastening pin that projects in the opposite direction to the interior face of the post;
the interior surface of the base bears a first tab which is connected, on the one hand, to a second tab which is connected to said fin and, on the other hand, to a third tab, the free end of which is intended to be engaged between first locking means that project from the internal face of the trim;
the first tab is connected to the base more or less in line with the clip-fastening pin;
the interior surface of the base bears a hook extending towards said fin intended to collaborate with second locking means that project from the internal face of the trim;
one of the ends of the base is curved away from the interior face of the post, this curved part being intended to be covered by said trim in such a way that a gap remains between this curved part and the trim;
the interior face of the fin bears a tab which extends between said second and third tabs and rests against the latter one.

Further particular features and advantages of the invention will become further apparent throughout the description which follows.

In the attached drawings, which are given by way of nonlimiting examples:

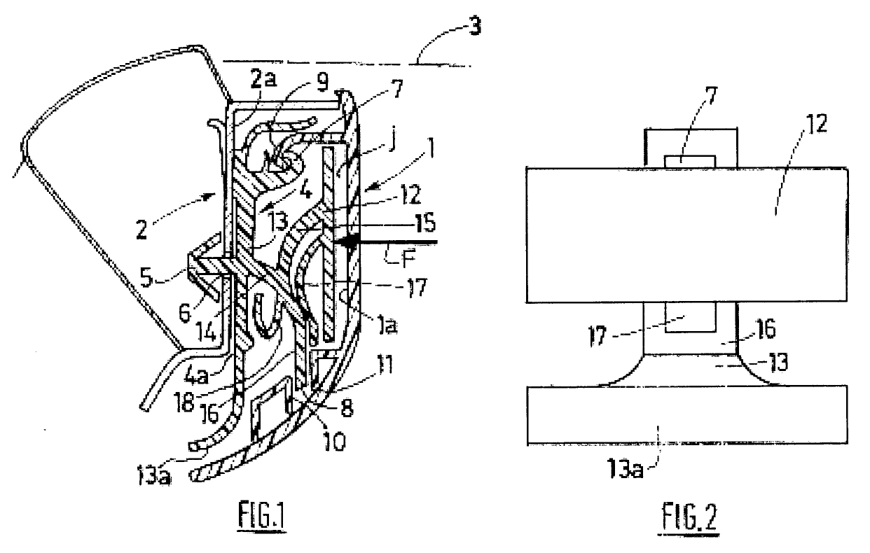

FIG. 1 is a view in section on a horizontal plane through a motor vehicle A-post to which a trim is attached using an attachment device according to the invention,

FIG. 2 is a plan view of an attachment device in the direction of the arrow F in FIG. 1.

As shown by FIGS. 1 and 2, the device for attaching a trim 1 to the interior face 2a of an A-post 2 flanking the windshield 3 of a motor vehicle comprises a series of clips 4 each comprising, at one end, attachment means 5 intended to be clipped into an opening 6 made in the interior face 2a of the post 2 and, at the opposite end, locking means 7, 8 intended to collaborate with complementary means 9, 10, 11 that project from the internal face of the trim 1 in order to lock this trim to the clip 4.

According to the invention, each clip 4 comprises, a certain distance away from its surface 4a that is intended to bear against the interior face 2a of the post 2 a fin 12 running substantially parallel to the internal surface of the post. This fin 12 is intended to be covered by the trim 1 in such a way that a gap j exists between the fin 12 and the trim 1. This gap j measures, for example, of the order of a few millimeters and is slightly smaller than the thickness of the headlining.

The surface 4a of the clip 4 that is intended to rest against the post 2 is formed on a base 13 which is separated from the fin 12 by flexible connecting tabs 14, 15, 16.

In the example depicted (see FIG. 1), the surface 4a of the clip 4 includes a clip-fastening pin 5 that projects in the opposite direction to the face 2a of the post 2.

Furthermore, the interior surface of the base 13 bears a first tab 14 which is connected, on the one hand, to a second tab 15 which is connected to said fin 12 and, on the other hand, to a third tab 16, the free end 8 of which is intended to be engaged between first locking means 10, 11 that project from the internal face of the trim 1.

As shown by FIG. 1, the first tab 14 is connected to the base 13 more or less in line with the clip-fastening pin 5.

On one of its sides, the interior surface of the base 13 bears a hook 7 extending towards the fin 12 intended to collaborate with second locking means 9 that project from the internal face 1a of the trim 1.

Furthermore, the opposite end of the base 13 to the hook 9 is curved in the opposite direction to the face 2a of the post 2. This curved part 13a is intended to be covered by the trim 1 in such a way that there is a gap of a few millimeters between this curved part 13a and the trim 1 into which the headlining can fit.

In addition, the interior face of the fin 12 bears a small tab 17 which extends between the second and third tabs 15, 16 and rests elastically against the latter one. Another small flexible tab 18 bent into a U-shape is provided between the third tab 16 and the base 13.

Of course, the clip 4 that has just been described is molded as a single piece in a flexible plastic, and its shape can vary to suit the geometry of the trim elements.

The attachment device that has just been described has the following main advantages:
the fin 12 of the clip 4 limits the “pumping effect” that is to say the movement of the headlining under the effect of pressure exerted in the region where the post trim meets the headlining;
the same effect is afforded by the curved part 13a of the base of the clip;
the flexible connection afforded by the tabs 14, 15, 16 positioned between the fin 12 and the base 13 of the clip absorbs the forces applied in the direction of the arrow F1 in FIG. 1. The tabs also allow for the attachment of the post trim.

In order to fit the device, once the headlining has already been fitted, the clip 4 is attached to the post and the post trim is mounted on the clip 4.

1-10. (canceled)

11: A device for attaching a trim to an interior face of a post flanking a window recess, in a motor vehicle, comprising:
a series of clips each comprising, at a first end, attachment means to be clipped into an opening made in an interior face of the post and, at a second opposite end, locking means to collaborate with complementary means that project from the internal face of the trim to lock the trim to the clip, and
wherein, between the clip and an internal face of the trim there, a gap is provided configured to accommodate a headlining.

12: The device as claimed in claim 11, wherein each clip comprises, a certain distance away from its surface configured to bear against the interior face of the post, a fin running substantially parallel to the internal surface of the post, the fin configured to be covered by the trim such that the gap exists between the fin and the trim.

13: The device as claimed in claim 11, further comprising a base of which one of the ends is curved away from the face of the post, the curved part being configured to be covered by the trim such that a gap remains between the curved part and the trim.

14: The device as claimed in claim 12, wherein the surface of the clip that is configured to rest against the post is formed on a base that is separated from the fin by flexible connecting tabs.

15: The device as claimed in claim 14, wherein the surface of the clip includes a clip-fastening pin that projects in the opposite direction to the face of the post.

16: The device as claimed in claim 15, wherein the interior surface of the base bears a first tab that is connected to a second tab connected to the fin and that is connected to a third tab, a free end of the third tab configured to be engaged between first locking means that project from the internal face of the trim.

17: The device as claimed in claim 16, wherein the first tab is connected to the base more or less in line with the clip-fastening pin.

18: The device as claimed in claim 13, wherein the interior surface of the base bears a hook extending towards the fin configured to collaborate with second locking means that project from the internal face of the trim.

19: The device as claimed in claim 16, wherein the interior face of the fin bears a tab that extends between the second and third tabs and rests against the third tab.

20: A fitting method employing the device as claimed in claim 11, comprising:
attaching, once the headlining has already been fitted, the clip to the post and mounting the post trim on the clip.
